(19) United States
(12) Patent Application Publication
(10) Pub. No.: US 2024/0155590 A1
(43) Pub. Date: May 9, 2024

(54) INFORMATION PROCESSING METHOD AND APPARATUS, AND COMMUNICATION DEVICE AND STORAGE MEDIUM

(71) Applicants: BEIJING XIAOMI MOBILE SOFTWARE CO., LTD., Beijing (CN); BEIJING UNIVERSITY OF POSTS AND TELECOMMUNICATIONS, Beijing (CN)

(72) Inventors: Yajun ZHU, Beijing (CN); Wei HONG, Beijing (CN); Lingyu GAO, Beijing (CN); Yong LI, Beijing (CN)

(73) Assignees: BEIJING XIAOMI MOBILE SOFTWARE CO., LTD., Beijing (CN); BEIJING UNIVERSITY OF POSTS AND TELECOMMUNICATIONS, Beijing (CN)

(21) Appl. No.: 18/549,743

(22) PCT Filed: Mar. 9, 2021
(86) PCT No.: PCT/CN2021/079695

§ 371 Date: Sep. 8, 2023

(51) Int. Cl. H04W 72/0453; H04L 5/00; H04W 16/14

(52) U.S. Cl. CPC H04W 72/0453; H04L 5/0051; H04W 16/14

(57) ABSTRACT

Embodiments of the present disclosure provide an information processing method and apparatus, and a communication device and a readable storage medium. The information processing method can include receiving first information sent by a network device, wherein the first information is correlated with a signature sequence of uplink data, monitoring transmission data on a shared frequency band resource, wherein the shared frequency band resource comprises a frequency band resource shared by a first UE and a second UE, and determining whether uplink transmission can be performed on the shared frequency band resource according to the correlation between the first information and data transmission features of the second UE on the shared frequency band resource.

### CROSS-REFERENCE TO RELATED APPLICATION

The application is a U.S. National Stage of International Application No. PCT/CN2021/07%95 filed on Mar. 9, 2021, the entire content of which is incorporated herein by reference for all purposes.

### BACKGROUND

### Technical Field

The present disclosure relates to, but is not limited to, the field of communication technologies, and in particular, to an information processing method and apparatus, a communication device, and a storage medium, DESCRIPTION OF THE RELATED ART

With the rapid growth of data, the available licensed frequency bands are saturated, and there is a serious shortage of spectrum. To address the shortage of spectrum, a new concept was introduced, namely unlicensed spectrum, which refers to a spectrum that can be used without authorization from the competent authority if satisfying the regulatory rules. Since the unlicensed frequency band has the characteristics of spectrum sharing, in order to ensure fair coexistence between nodes in the system and with other access technologies, New Radio in Unlicensed Spectrum (NR-U) adopts the channel access mechanism based on Listen Before Talk (LBT), that is, the sender needs to perform channel idle detection before transmission, and can occupy the channel after the detection is successful. And for high data rate communication, the NR band is extended from 52.6 GHz to up to 71 GHz. In the high frequency range, NR-U/Wi-Fi always requires the use of beamforming to overcome the large propagation loss. Therefore, directional LBT should be used for directional transmission.

In order to improve the channel access mechanism based on directional LBT, a method of sharing Channel Occupancy Time (COT) based on directional LBT is proposed. If a plurality of User Equipments (UEs) share a COT initiated by one SG base station (gNB), the beam direction and beam width from each UE to the gNB may be different, therefore methods should be studied to ensure that COT sharing is fair to other Radio Access Technologies (RATs) and uncoordinated networks.

NR or NR-U supports Multi-User Multiple-input Multiple-Output (MU-MIMO), that is, the base station can schedule a plurality of UEs in the same time-frequency domain resources. In this case, the mechanism of a plurality of UEs sharing one COT needs to be discussed separately according to different detailed scenarios, and there may be some problems in some scenarios.

### SUMMARY

The embodiments of the present disclosure disclose an information processing method and apparatus, a communication device, and a storage medium.

According to a first aspect of the embodiments of the present disclosure, there is provided an information processing method, the method is executed by a first UE, and the method includes receiving first information sent by a network device, where the first information is related to a feature sequence of uplink data, monitoring data transmission on a shared frequency band resource, where the shared frequency band resource includes a frequency band resource shared by the first UE and a second UE, and determining whether an uplink transmission can be performed on the shared frequency band resource according to a correlation between the first information and a data transmission characteristic of the second UE on the shared frequency band resource.

According to a second aspect of the embodiments of the present disclosure, there is provided an information processing apparatus, including a transceiver module, configured to receive first information sent by a network device, and configured to monitor data transmission on a shared frequency band resource; where the first information is related to a feature sequence of uplink data; where the shared frequency band resource includes a frequency band resource shared by the first UE and a second UE, a processing module, configured to determine whether an uplink transmission can be performed on the shared frequency band resource according to a correlation between the first information and a data transmission characteristic of the second UE on the shared frequency band resource.

According to a third aspect of the embodiments of the present disclosure, there is provided a communication device, including a processor and a memory for storing executable instructions of the processor. The processor is configured to implement the information processing method according to any embodiment of the present disclosure when executing the executable instructions.

According to a fourth aspect of the embodiments of the present disclosure, there is provided a non-transitory computer-readable storage medium, where the computer-readable storage medium stores instructions that, when executed by a processor, implement the information processing method according to any embodiment of the present disclosure.

The technical solutions provided by the embodiments of the present disclosure may include at least the following beneficial effects. In the embodiments of the present disclosure, the first UE receives the first information sent by the network device, where the first information is related to the feature sequence of the uplink data; the transmission data on the shared frequency band resource is monitored, where the shared frequency band resource includes the frequency band resource shared by the first UE and the second UE; and whether the uplink transmission can be performed on the shared frequency band resource is determined according to the correlation between the first information and the data transmission characteristic of the second UE on the shared frequency band resource. In this way, in the embodiments of the present disclosure, when data transmission is found on the shared frequency band resource of the first UE and the second UE, whether the first UE can perform data transmission on the shared frequency band resource is determined through the first information related to the feature sequence of the uplink data sent by the second UE and the correlation of data characteristic of the second UE on the shared frequency band, and in this way, the situation in which the first UE determines that it can perform uplink transmission on the shared frequency band resource, but the opportunity of performing the transmission is lost due to finding the second UE transmitting data on the shared frequency band resource can be reduced, which can greatly improve the utilization rate of the shared frequency band resource.

It is to be understood that the foregoing general description and the following detailed description are exemplary and explanatory only and are not restrictive of the present disclosure.

### BRIEF DESCRIPTION OF THE DRAWINGS

Various exemplary embodiments of this disclosure that are proposed as examples will be described in detail with reference to the following figures, wherein like numerals reference like elements, and wherein:

FIG. 1 is a schematic structural diagram of a wireless communication system.

FIG. 2 is a schematic diagram of a COT initiated by a base station shared by a plurality of UEs.

FIG. 3 is a schematic diagram of an information processing method according to an exemplary embodiment.

FIG. 4 is a schematic diagram showing one resource block according to an exemplary embodiment.

FIG. 5 is a schematic diagram showing one resource block according to an exemplary embodiment.

FIG. 6 is a schematic diagram illustrating an information processing method according to an exemplary embodiment.

FIG. 7 is a schematic diagram illustrating an information processing method according to an exemplary embodiment.

FIG. 8 is a schematic diagram illustrating an information processing method according to an exemplary embodiment.

FIG. 9 is a schematic diagram illustrating an information processing method according to an exemplary embodiment.

FIG. 10 is a schematic diagram showing an information processing method according to an exemplary embodiment.

FIG. 11 is a block diagram of an information processing apparatus according to an exemplary embodiment.

FIG. 12 is a block diagram of a UE according to an exemplary embodiment.

FIG. 13 is a block diagram of a base station according to an exemplary embodiment.

### DETAILED DESCRIPTION OF THE PREFERRED EMBODIMENTS

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the embodiments of the present disclosure. Instead, they are merely examples of apparatuses and methods consistent with some aspects related to the embodiments of the present disclosure as recited in the appended claims.

The terms used in the embodiments of the present disclosure are for the purpose of describing particular embodiments only and are not intended to limit the embodiments of the present disclosure. As used in the embodiments of the present disclosure and the appended claims, the singular forms “a/an”, and “the” are intended to include the plural forms as well, unless the context clearly dictates otherwise. It should also be understood that the term “and/or” as used herein refers to and includes any and all possible combinations of one or more of the associated listed items.

It should be understood that although the terms first, second, third, etc. may be used in the embodiments of the present disclosure to describe various pieces of information, such information should not be limited by these terms. These terms are only used to distinguish the same type of information from each other. For example, the first information may also be referred to as second information, and similarly, the second information may also be referred to as the first information, without departing from the scope of the embodiments of the present disclosure. Depending on the context, the word “if” as used herein can be interpreted as “at the time of” or “when” or “in response to determining”.

FIG. 1 shows a schematic structural diagram of a wireless communication system provided by an embodiment of the present disclosure. As shown in FIG. 1, the wireless communication system is a communication system based on cellular mobile communication technology, and the wireless communication system may include: several user equipments 110 and several base stations 120.

The user equipment 110 may refer to a device that provides voice and/or data connectivity to the user. The user equipment 110 may communicate with one or more core networks via a Radio Access Network (RAN), and the user equipment 110 may be IoT user equipment, such as a sensor device, a mobile phone (or a “cellular” phone), and may be a computer with IoT user equipment, for example, which may be a stationary, portable, pocket-sized, hand-held, computer-built or vehicle-mounted apparatus. For example, it may be a Station (STA), a subscriber unit, a subscriber station, a mobile station, a mobile, a remote station, an access point, a remote user equipment (a remote terminal), an access terminal, a user terminal, a user agent, a user device, or a user equipment. Alternatively, the user equipment 110 may also be a device of an unmanned aerial vehicle. Alternatively, the user equipment 110 may also be an in-vehicle device, for example, a trip computer with a wireless communication function, or a wireless user equipment connected to an external trip computer. Alternatively, the user equipment 110 may also be a roadside device, for example, a streetlight, a signal light, or other roadside devices with a wireless communication function.

The base station 120 may be a network-side device in the wireless communication system. The wireless communication system may be a fourth generation mobile communication (the 4th generation mobile communication, 4G) system, also known as a Long Term Evolution (LTE) system; or, the wireless communication system may also be a 5G system, also known as new radio system or 5G NR system. Alternatively, the wireless communication system may also be a next-generation system of the 5G system. Among them, the access network in the 5G system may be called a New Generation-Radio Access Network (NG-RAN).

The base station 120 may be an evolved base station (eNB) used in the 40 system. Alternatively, the base station 120 may also be a base station (gNB) that adopts a centralized distributed architecture in the 5G system. When the base station 120 adopts the centralized distributed architecture, it usually includes a central unit (CU) and at least two distributed units (DUs). The central unit is provided with protocol stacks of a Packet Data Convergence Protocol (PDCP) layer, a Radio Link Control (RLC) layer, and a Medium Access Control (MAC) layer; the distributed units are provided with a protocol stack of a Physical (PHY) layer, and a specific implementation manner of the base station 120 is not limited in the embodiments of the present disclosure.

A wireless connection can be established between the base station 120 and the user equipment 110 through a wireless air interface. In different embodiments, the wireless air interface is a wireless air interface based on the fourth generation mobile communication network technology (4G) standard; or, the wireless air interface is a wireless air interface based on the fifth generation mobile communication network technology (SG) standard, for example, the wireless air interface is a new air interface; alternatively, the wireless air interface may also be a wireless air interface based on a 5G next-generation mobile communication network technology standard.

In some embodiments, an End to End (EE) connection may also be established between the user equipments 110, for example, the scenarios such as vehicle to vehicle (V2V) communication, vehicle to infrastructure (V2I) communication and vehicle to pedestrian (V2P) communication in vehicle-to-everything (V2X) communication.

Here, the above-mentioned user equipment may be regarded as the terminal device of the following embodiments.

In some embodiments, the above wireless communication system may further include a network management device 130.

Several base stations 120 are respectively connected to the network management device 130. The network management device 130 may be a core network device in the wireless communication system, for example, the network management device 130 may be a Mobility Management Entity (MME) in an Evolved Packet Core (EPC). Alternatively, the network management device may also be other core network devices, such as a Serving GateWay (SGW), a Public Data Network GateWay (PGW), a Policy and Charging Rules Function (PCRF) or a Home Subscriber Server (HSS), etc. The implementation form of the network management device 130 is not limited in the embodiments of the present disclosure.

In order to better understand the technical solutions described in any of the embodiments of the present disclosure, first of all, some descriptions are given for a plurality of UEs sharing a frequency band resource.

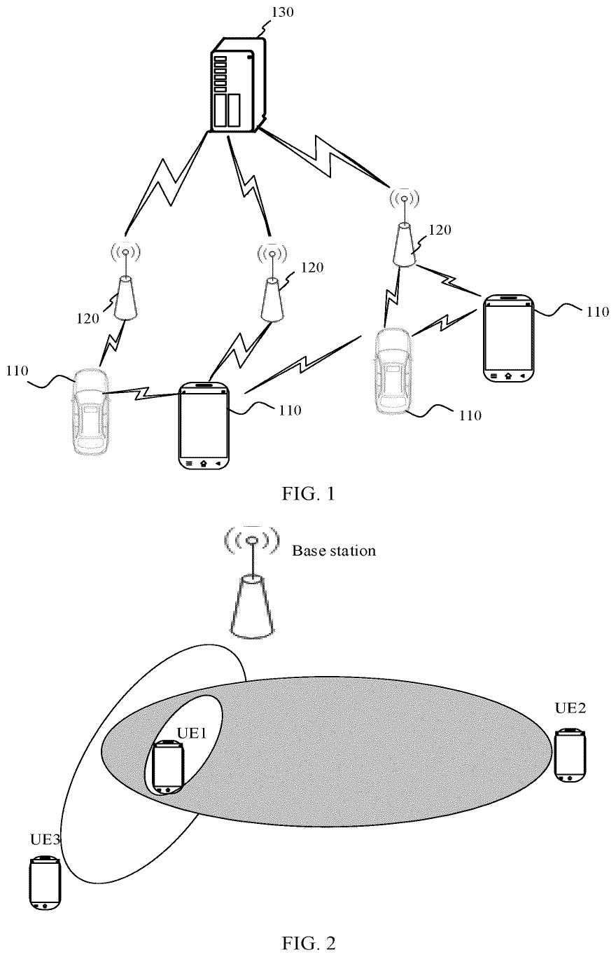

Currently, for high data rate communications, the NR frequency band can be extended from 52.6 GHz to up to 71 GHz and above. In the high frequency band range, NR-U/WiFi may require the use of beamforming to overcome large propagation losses; for example, directional LBT can be used for directional transmission. If NR/NR-UE supports multi-user multiple-input multiple-output (MU-MIMO), that is, the base station can schedule a plurality of UEs in the same time-frequency domain resource; in this scenario, the mechanism for a plurality of UEs to share one frequency band resource needs to be separately discussed based on different refined scenarios. For example, in the application scenario shown in FIG. 2, the scenario proposes the following assumptions:
(1) there are three UEs in the uplink (UL) direction, which are respectively UE1, UE2 and UE3; the three UEs share one frequency band resource;
(2) both the base station and the three UEs use directional LBT for channel access;
(3) the beam direction and beam width of each of the three UEs with respect to the base station may be different. Assuming that the transmit beam range of UE2 is relatively large, the transmit beam range of UE2 covers the transmit beam range of UE1; while the transmit beam range of UE3 is not within the transmit beam coverage of any UE, the transmit beam directions of UE3 and LE1 are basically the same;
(4) the time-frequency domain resources of UE1, UE2 and UE3 may have an overlapping part.

As shown in the application scenario in FIG. 2 above, the beam direction and beam width of each UE with respect to the base station are not exactly the same; the transmit beam range of UE1 is located in the transmit beam range of UE2, and the transmit beam directions of UE1 and UE2 are basically the same. In this application scenario, UE is an important object that easily causes interference. Whether UE1 can send uplink data not only depends on the result of monitoring the channel during LBT, but also needs to consider more factors. The sharing of one frequency band resource by the three UEs here may be considered as the three UEs sharing a COT initiated by one base station.

For example, in one embodiment, the reason that UE1 detects that the channel is busy and thus the LBT monitoring failure is caused, includes at least the following two reasons.

First reason: since the transmit beam coverage of UE1 is within the transmit beam range of UE2, the uplink data transmission of UE2 may interfere with the LBT result of UE1; however, UE2 may not occupy the channel of UE1 at this time. In this application scenario, if there is only interference from UE2's data transmission, the result of UE1 performing LBT is not credible. At this time, UE1 can actually transmit uplink data on its own channel.

Second reason: since the uplink data transmission of UE3 occupies the channel of UE1, it may cause interference to the LBT result of UE1. In this application scenario, UE1 cannot perform uplink data transmission, otherwise it will conflict with the uplink data transmission of UE3.

In the above application scenarios, the uplink data transmission of UE2 may be considered as a known interference, and the uplink data transmission of UE3 may be considered as an unknown interference. Moreover, the above-mentioned transmit beam range of UE1 is located within the transmit beam range of UE2, and it can be considered that UE1 and UE2 are a coverage interference pair.

In this way, for the above-mentioned UE1, it does not know whether the LBT failure is caused by the above-mentioned first reason or second reason; UE1 cannot generate different behaviors for different failure reasons; this will cause UE1 to think that uplink data transmission cannot be performed and lose the opportunity for transmission that could have been possible, thereby reducing the utilization rate of the shared frequency band resource.

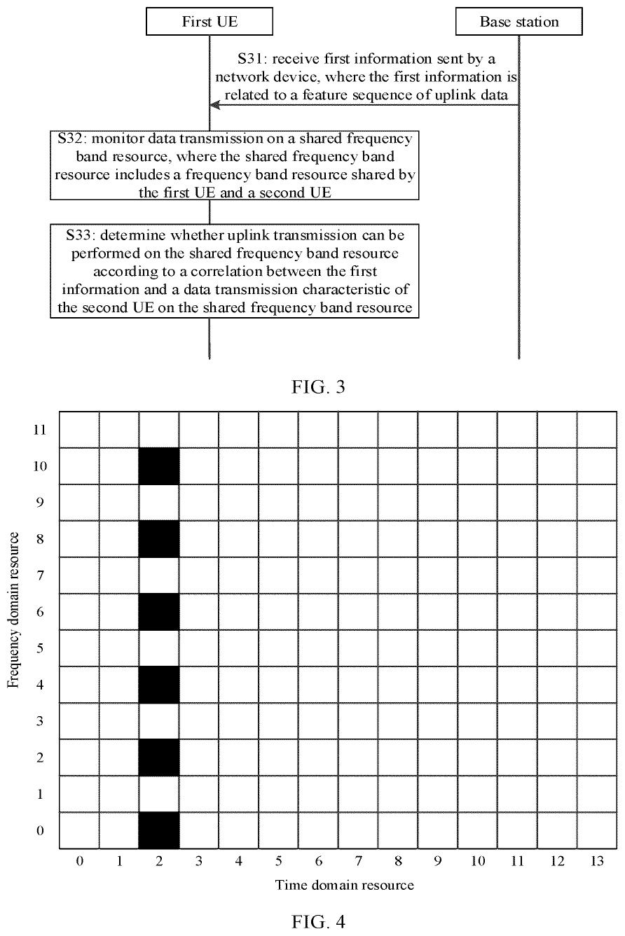

As shown in FIG. 3, an information processing method is provided, and the method is executed by a first UE. The method includes the following steps.

In step S31: first information sent by a network device is received, where the first information is related to a feature sequence of uplink data.

In step S32: data transmission on a shared frequency band resource is monitored, where the shared frequency band resource includes a frequency band resource shared by the first UE and a second UE.

In step S33: it is determined whether uplink transmission can be performed on the shared frequency band resource according to a correlation between the first information and a data transmission characteristic of the second UE on the shared frequency band resource.

In one embodiment, both the first UE and the second UE may be various mobile terminals or fixed terminals. For example, both the first UE and the second UE may be, but not limited to, a mobile phone, a computer, a server, a wearable device, a game control platform, or a multimedia device.

In one embodiment, the network device includes: a base station. For example, the above step S31 may be: receiving first information sent by the base station.

In one embodiment, the base station may be an interface device for the UE to access the Internet. The base station may be various types of base stations: for example, 3G base station, 4G base station, SG base station, or other evolved base stations.

In other embodiments, the network device may also be a core network or a network-side entity in a radio access network, or the like.

In one embodiment, the first UE and the second UE share one shared channel. For example, the first UE and the second UE share the channel occupancy time. For another example, the first UE and the second UE share one shared frequency band resource. For another example, the first UE and the second UE share one shared time-frequency domain resource.

Here, two or more than two UEs may share one shared frequency band resource. For example, one first IE and one second UE share one shared frequency band resource; in another example, one first UE and a plurality of second UEs share one shared frequency band resource.

In one embodiment, the first UE and the second UE share one shared channel, which may be sharing a shared channel of the same base station.

In one embodiment, the first information is related to a feature sequence of uplink data sent by the second UE. For example, the first information includes: a feature sequence for indicating uplink data sent by the second UE, or any information for determining the feature sequence of uplink data sent by the second UE. For example, the first information may refer to the feature information of DMRS of the uplink data sent by the second UE, and the like.

In one embodiment, the first information includes but is not limited to at least one of the following:
demodulation reference signal (Dedicated Reference Signal, DMRS) configuration information, used for the second UE to transmit the DMRS according to the DMRS configuration information;
DMRS indication information, used for indicating the feature information obtained by jointly encoding each DMRS configuration information.

In one embodiment, the DMRS configuration information includes but is not limited to at least one of the following:
time domain resource information of a time domain resource for transmitting DMRS;
frequency domain configuration information of a frequency domain resource for transmitting DMRS;
indication information for indicating a transmission mode for transmitting DMRS;
type information of the DMRS; where the type information of the DMRS is for indicating whether the DMRS is a precoding DMRS.

The DMRS here is the DRMS of the uplink data sent by the second UE. In one embodiment, the MDRS configuration information and/or the DMRS indication information is information for indicating a feature sequence of uplink data sent by the second UE. For example, the DMRS configuration information and/or the DMRS indication information may be considered as priori information of uplink data sent by the second UE.

Exemplarily, as shown in FIG. 4, one resource block (RB) includes a time-domain resource of one slot and 12 subcarriers in the frequency domain; where one slot has 14 symbols; one symbol and one subcarrier constitute one time-frequency domain resource element (RE). The numbering sequence of 14 symbols is from 0 to 13, such as 0, 1, 2, . . . 12 and 13; the numbering sequence of 12 subcarriers is 0 to 11, such as 0, 1, 2, . . . 10 and 11. The DMRS configuration information here may be for indicating the time-frequency domain resource information for transmitting the DMRS; for example, for indicating one or more resource blocks.

In one embodiment, the time domain resource information includes at least one of the following:
the number of symbols; the number of symbols is for indicating the number of symbols for sending DMRS;
symbol distribution information; the symbol distribution information is for indicating the number of symbols continuously occupied by sending DMRS in the time domain;
a time domain starting position; the time domain starting position is for indicating the position of the first symbol occupied by the DMRS in the time domain;
a symbol position; the symbol position is for indicating the sequence of symbols occupied by the DMRS.

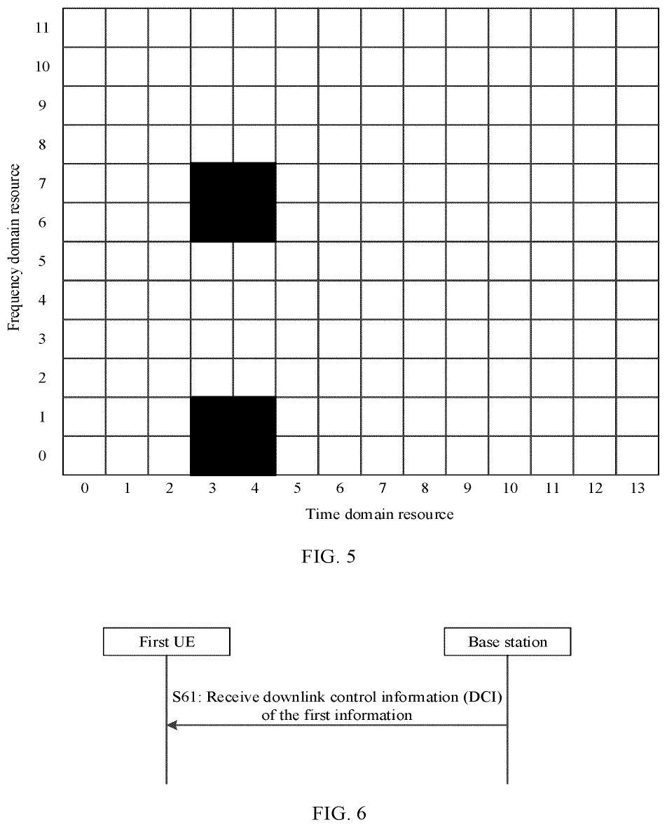

Exemplarily, the time domain resource information of the time domain resource for transmitting the DMRS includes the number of symbols. For example, as shown in FIG. 4, the number of symbols indicates that the number of symbols for transmitting DMRS is 1; for another example, as shown in FIG. 5, the number of symbols is for indicating that the number of symbols for transmitting DMRS is 2.

Exemplarily, the time domain resource information of the time domain resource for transmitting the DMRS includes symbol distribution information. For example, as shown in FIG. 4, the symbol distribution information includes: single-symbol distribution information; where the single-symbol distribution information is for indicating that the number of symbols continuously occupied by sending DMRS in the time domain is 1. For another example, as shown in FIG. 5, the symbol distribution information includes: dual-symbol distribution information; where the dual-symbol distribution information is for indicating that the number of symbols continuously occupied by sending DMRS in the time domain is 2.

In other embodiments, the symbol distribution information may be “0”, which is for indicating that the number of symbols continuously occupied by sending DMRS in the time domain is 1; the symbol distribution information may be “1”, which is for indicating that the number of symbols continuously occupied by sending DMRS in the time domain is 2.

Exemplarily, the time domain resource information of the time domain resource for transmitting the DMRS includes a time domain starting position. For example, as shown in FIG. 4, the time domain starting position is for indicating that the position of the first symbol occupied by the DMRS is the second symbol. For another example, as shown in FIG. 5, the time domain starting position is for indicating that the position of the first symbol occupied by the DMRS is the third symbol. In other embodiments, the time domain starting position is for indicating that the position of the first symbol occupied by sending DMRS may also be other symbols or symbols in other columns, for example, may be the first symbol, the fourth symbol or the fifth symbol, etc.

In other embodiments, the time domain starting position may also refer to the time domain starting position of the front-loaded DMRS. The DMRS in 5G NR adopts the front-loaded design idea, and the DMRS can be called front-loaded DMRS.

Exemplarily, the time domain resource information of the time domain resource for transmitting the DMRS includes a symbol position. For example, as shown in FIG. 4, the symbol position is for indicating that the sequence of the symbols occupied by the DMRS is the second column. For another example, as shown in FIG. 5, the symbol position is for indicating that the sequences of the symbols occupied by the DMRS are the third column and the fourth column. For other embodiments, the symbol position may also indicate other column numbers of the symbols occupied by the DMRS.

Exemplarily, the time domain resource position of the time domain resource for transmitting the DMRS includes: the maximum number of symbols. For example, the maximum number of symbols may be the number of symbols occupied by one slot, for example, 14 symbols. In other embodiments, the maximum number of symbols may be other numbers, such as 8, 10, or 3, and so on.

In other embodiments, the first information may also be: a DMRS sequence. For example, the first information may be one or more DMRS sequences. In one embodiment, one DMRS sequence may indicate the time domain resource information of one resource block for transmitting the DMRS.

Exemplarily, the frequency domain configuration information of the frequency domain resource for transmitting DMRS may be frequency domain resource information of the frequency domain resource for transmitting DMRS. For example, as shown in FIG. 5, the frequency domain resource information may be the 0th and 1st subcarriers, the 6th and 7th symbols.

In other embodiments, the frequency domain configuration information of the frequency domain resource for transmitting DMRS may also be other frequency domain configuration information, for example, may be frequency domain multiplexing mode information and the like.

In one embodiment, the indication information for indicating the transmission mode of the DMRS includes at least one of the following:
frequency domain multiplexing mode information, for indicating that the DMRS is transmitted by using the frequency domain multiplexing mode;
frequency hopping indication information, for indicating whether there is frequency hopping transmission of the DMRS.

In one embodiment, the frequency division multiplexing mode is for indicating that one or more columns of DMRS are transmitted by using the frequency domain multiplexing mode.

In one embodiment, the frequency domain multiplexing mode includes: type 1 or type 2: where the code division multiplexing (CDM) groups of type 1 are 2 groups, and the CDM groups of type 2 are 3 groups. For example, as shown in FIG. 4, in the second column of symbols, 2 groups of CDM are used. For another example, as shown in FIG. 5, in the symbols in the second column and the third column, 3 groups of CDMs are respectively used.

In one embodiment, the transmission mode indication information includes: intra-CDM-group multiplexing mode information, which is for indicating the support of multiplexing different number of ports for transmitting the DMRS with respect to CDM groups of different numbers. For example, as shown in FIG. 4, in the second column of symbols, if the frequency domain multiplexing mode for 2 groups of CDM is used for transmission, up to 4 ports can be supported to be multiplexed; for example, for the DMRS of the (A subcarrier, 2 ports of 0 and 1 are supported to be multiplexed, etc. For another example, as shown in FIG. 5, in the second and third columns of symbols, if the frequency domain multiplexing mode for three groups of CDM is used for transmission, up to 12 ports can be supported to be multiplexed; for example, for the DMRS of the 0^{th} symbol, multiplexing of 4 ports of ports 0, 1, 6 and 7 is supported, etc.

Exemplarily, when the frequency hopping indication information is “0”, it is for indicating that the DMRS does not have frequency hopping; when the frequency hopping indication information is “1”, it is for indicating that the DMRS has frequency hopping.

In one embodiment, the frequency hopping indication information is for indicating whether the DMRS has frequency hopping transmission in one slot. In another embodiment, the frequency hopping indication information is for indicating whether the DMRS has frequency hopping transmission between slots.

Exemplarily, as shown in FIG. 4, there is frequency hopping transmission in the second column of symbols in one slot. In other embodiments, the frequency hopping indication information may also indicate whether there is frequency hopping transmission between slots, or whether there is frequency hopping transmission between different frequency bands, and so on.

Exemplarily, the DMRS configuration information may include type information of DMRS. For example, when the type information of the DMRS is “0”, it is for indicating that the DMRS is not a precoding DMRS; when the type information of the DMRS is “1”, it is for indicating that the DMRS is a precoding DMRS.

In the embodiments of the present disclosure, the first UE may acquire first information related to a feature sequence of uplink data sent by the second UE, for example, acquire time domain resource information of the time frequency resource and frequency domain resource information of the frequency domain resource for transmitting DMRS, transmission mode indication information for transmitting DMRS, and type information of DMRS, such as at least one or more of the number of symbols, symbol distribution information, time domain starting position, symbol position, frequency domain multiplexing mode information, frequency hopping indication information. In this way, the embodiments of the present disclosure can acquire the priori information (i.e., the first information) of the feature sequence of uplink data sent by the second UE that shares the same frequency domain resource with the first UE; which facilitates the correlation detection of data transmission characteristics on the shared frequency band resource based on the priori information by the first UE.

In one embodiment, the first information includes DMRS indication information. For example, the DMRS indication information is for indicating the feature information obtained by jointly coding at least two of the number of symbols, the symbol distribution information, the time domain starting position, the symbol position, the frequency domain multiplexing mode information, the frequency hopping indication information. For another example, the DMRS indication information may also be the feature information obtained by jointly encoding at least two DMRS sequences in individual DMRS sequences. In this way, in the embodiments of the present disclosure, individual DMRS configuration information, such as the number of symbols, the symbol distribution information, the time domain starting position, the symbol position, the frequency division multiplexing mode, and the frequency hopping indication information, etc. are jointly encoded to obtain one jointly encoded feature information (such as a feature sequence, etc.); this is helpful for the first UE to perform correlation detection of data transmission characteristic on the shared frequency band resource based on the jointly encoded feature information.

In the embodiments of the present disclosure, when the first UE detects the data transmission on the shared frequency band resource of the first UE and the second UE, by detecting the correlation between the first information and the data characteristic of the second UE on the shared frequency band, it is determined whether the first UE can perform data transmission on the shared frequency band resource. In this way, the embodiments of the present disclosure can reduce the occurrence of situations where the first UE determines that it can perform uplink transmission on the shared frequency band resource, but loses the opportunity of transmission due to detecting the existence of transmission data on the shared frequency band resource, and can greatly improve the utilization rate of the shared frequency band resource.

For example, in the application scenario shown in FIG. 2, if UE1 detects the data transmission of UE2 on the shared frequency band resource, it determines whether it is caused by the first reason or the second reason. If it is caused by the first reason, it can be determined that the UE1 can still perform uplink transmission based on the shared frequency band resource.

The monitoring of the transmission data on the shared frequency band resource in the above step S32 may be to monitor the transmission data of any UE on the shared frequency band resource; any UE only needs to satisfy the condition of having the shared frequency band resource with the first UE.

In one embodiment, the data transmission on the shared frequency band resource being detected in the foregoing step S32 includes: detecting the data transmission of the second UE on the shared frequency band resource.

In one embodiment, the above step S33 includes: if the data transmission on the shared frequency band resource is detected, determining whether the data transmission on the shared frequency band resource can be performed according to the correlation between the first information and the data transmission characteristic of the second UE on the shared frequency band resource. In this way, in the embodiments of the present disclosure, only when data transmission on the shared frequency band is detected, that is, when the shared frequency band resource is relatively busy, the correlation detection between the first information and the data transmission characteristic of the second UE on the shared frequency band resource is performed, so as to improve the detection efficiency.

It should be noted that those skilled in the art can understand that the methods provided in the embodiments of the present disclosure may be executed alone, or may be executed together with some methods in the embodiments of the present disclosure or some methods in the related art.

As shown in FIG. 6, an information processing method is provided, and the method is executed by a first UE. The method includes the following steps.

In step S61: downlink control information (DCI) of the first information is received.

An embodiment of the present disclosure provides an information processing method. The method is executed by a first UE, and may include: receiving DCI sent by a network device, where the DCI carries the first information.

Exemplarily, the first UE receives the DCI delivered by the base station, where the DCI carries the first information. For example, at least one information field of the DCI carries the first information.

In some embodiments of the present disclosure, the first information may be the first information described in the foregoing step S31.

Exemplarily, the DCI received by the first UE carries one or more of time domain resource information of a time domain resource for transmitting DMRS, frequency domain configuration information of a frequency domain resource for transmitting DMRS, transmission mode indication information for transmitting DMRS, and type information for transmitting DMRS. When the first LIE acquires that the second UE uses the same time domain resource information of the time domain resource for transmitting DMRS as the first UE, the DCI may only carry one or more of the frequency domain configuration information of the frequency domain resource for transmitting DMRS, the transmission mode indication information for transmitting DMRS and type information for transmitting DMRS.

In some embodiments, the above step S31 includes: receiving downlink control information (DCI) including the first information.

In the embodiments of the present disclosure, the first information can be received through DCI; in this way, the first UE can accurately know the situation that the first UE estimates the uplink transmission of the second UE, and the utilization rate of the DCI can be improved.

It should be noted that those skilled in the art can understand that the methods provided in the embodiments of the present disclosure may be executed alone, or may be executed together with some methods in the embodiments of the present disclosure or some methods in the related art.

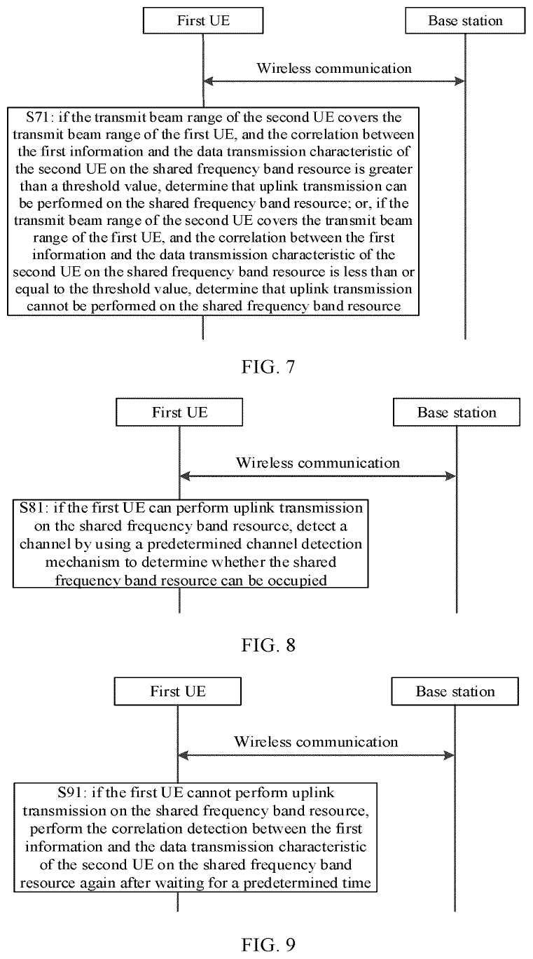

As shown in FIG. 7, an information processing method is provided, and the method is executed by a first UE. The method includes the following steps.

In step S71: if the transmit beam range of the second UE covers the transmit beam range of the first UE, and the correlation between the first information and the data transmission characteristic of the second UE on the shared frequency band resource is greater than a threshold value, it is determined that uplink transmission can be performed on the shared frequency band resource; or, if the transmit beam range of the second UE covers the transmit beam range of the first UE, and the correlation between the first information and the data transmission characteristic of the second UE on the shared frequency band resource is less than or equal to the threshold value, it is determined that uplink transmission cannot be performed on the shared frequency band resource.

In some embodiments of the present disclosure, the first information may be the first information described in the foregoing step S31.

An embodiment of the present disclosure provides an information processing method, the method is executed by a first UE, and may include: if the transmit beam range of the second UE covers the transmit beam range of the first UE and a signal peak value in the first information and the time-frequency domain resource corresponding to the first information is greater than a threshold peak value, it is determined that uplink transmission can be performed on the shared frequency band resource.

An embodiment of the present disclosure provides an information processing method, the method is executed by a first UE, and may include: if the transmit beam range of the second UE covers the transmit beam range of the first UE, and the signal peak value in the first information and the time-frequency domain resource corresponding to the first information is less than or equal to the threshold value, it is determined that the uplink transmission cannot be performed on the shared frequency band resource.

Exemplarily, if the first information is the time domain resource information of the time domain resource for transmitting DMRS, for example, if the time domain resource information indicates that the second to sixth symbols of the first slot transmit the DMRS, and if the signal peak value detected in the second to sixth symbols of the first slot is greater than the threshold value, it is determined that the second UE performs uplink data transmission in the second to sixth symbols of one slot. At this time, since the transmit beam range of the second UE covers the transmit beam range of the first UE, it is determined that the second UE is a known interference object; and it is determined that the UE sending uplink data on the shared frequency band resource is a known interference object, then it is determined that the first UE can perform uplink transmission on the shared frequency band resource.

Exemplarily, if the first information is the time domain resource information of the time domain resource for transmitting the DMRS, for example, if the time domain resource information indicates that the second to sixth symbols of the first slot transmit the DMRS, and if the signal peak value detected in the second to sixth symbols of the first slot is less than or equal to the threshold value, it is determined that the second UE does not actually perform uplink data transmission in the second to sixth symbols of one slot, and it is determined that there is UE(s) other than the second UE that performs uplink data transmission in the second to sixth symbols of one slot; in the application scenario shown in FIG. 2, UE1 determines that UE2 does not perform data transmission, and determines that UE3 performs uplink data transmission. At this time, the first UE determines that the interference object affecting the first UE is not the second UE, but an unknown interference object, such as the third UE that does not cover the transmit beam range of the first UE, and then it is determined that the first UE cannot perform uplink transmission on the shared frequency band resource.

Exemplarily, the first information is time domain resource information of the time frequency resource for transmitting DMRS and frequency domain resource information of the frequency domain resource for transmitting DMRS; that is, the time-frequency domain resource information of the time-frequency domain resource for transmitting DMRS. For example, if the time-frequency domain resource information indicates that the DMRS is transmitted in the time-frequency domain resources of the 2nd to 4th symbols of the 2nd slot and the 5th to 6th subcarriers, and if the signal peak value detected in the time-frequency domain resources of the 2nd to 4th symbols of the 2nd slot and the 5th to 6th subcarriers is greater than the threshold value, then it is determined that the second UE performs uplink data transmission on the time-frequency domain resources of the 2nd to 4th symbols of the 2nd slot and the 5th to 6th subcarriers. At this time, since the transmit beam range of the second UE covers the transmit beam range of the first UE, it is determined that the second UE is a known interference object; and it is determined that the UE sending uplink data on the shared frequency band resource is a known interference object, then it is determined that the first UE can perform uplink transmission on the shared frequency band resource.

Exemplarily, in the above example, if it is detected that the signal peak value in the time-frequency domain resources of the 2nd to 4th symbols of the 2nd slot and the 5th to 6th subcarriers is less than or equal to the threshold value, it is determined that the second UE does not actually perform the uplink data transmission on the time-frequency domain resources of the 2nd to 4th symbols of the 2nd slot and the 5th to 6th subcarriers, and it is determined that other UE except the second UE performs uplink data transmission on the time-frequency domain resources of the 2nd to 4th symbols of the 2nd slot and the 5th to 6th subcarriers. At this time, the first UE determines that the interference object affecting the first UE is an unknown interference object, and then determines that the first UE cannot perform uplink transmission on the shared frequency band resource.

Exemplarily, it is possible to determine that the first UE can perform uplink transmission on the shared frequency band resource if it is detected that the signal peak value in the time-frequency domain resource indicated by other information in the first information, such as at least one of symbol distribution information, frequency domain multiplexing mode information, frequency hopping indication information, or intra-CDM-group multiplexing mode information, etc., is greater than the threshold value; or, it is possible to determine that the first UE cannot perform uplink transmission on the shared frequency band resource if it is detected that the signal peak value in the time-frequency domain resources indicated by at least one of the symbol distribution information, frequency domain multiplexing mode information, frequency hopping indication information, or intra-CDM-group multiplexing mode information, etc. is less than or equal to the threshold value.

In some embodiments, the signal peak value may be, but is not limited to, the peak value of Reference Signal Receiving Power (RSRP) and/or Reference Signal Receiving Quality (RSRQ). In other embodiments, the signal peak value may be a peak value of any signal representing data transmission on the shared frequency band.

In some embodiments, the above step S31 includes one of the following:
if the transmit beam range of the second UE covers the transmit beam range of the first UE, and the correlation between the first information and the data transmission characteristic of the second UE on the shared frequency band resource is greater than the threshold value, determining that uplink transmission can be performed on the shared frequency band resource; or,
if the transmit beam range of the second UE covers the transmit beam range of the first UE, and the correlation between the first information and the data transmission characteristic of the second UE on the shared frequency band resource is less than or equal to the threshold value, determining that uplink transmission cannot be performed on the shared frequency band resource.

In some embodiments, if the transmit beam range of the second UE covers the transmit beam range of the first UE, and the correlation between the first information and the data transmission characteristic of the second UE on the shared frequency band resource is greater than the threshold value, determining whether uplink transmission can be performed on the shared frequency band resource, includes:
if the transmit beam range of the second UE covers the transmit beam range of the first UE, and signal peak value in the first information and the time-frequency domain resource corresponding to the first information is greater than a threshold peak value, determining that uplink transmission can be performed on the shared frequency band resource.

In some embodiments, if the transmit beam range of the second UE covers the transmit beam range of the first UE, and the correlation between the first information and the data transmission characteristic of the second UE on the shared frequency band resource is less than or equal to a threshold value, determining that uplink transmissions cannot be performed on the shared frequency band resource, includes:
if the transmit beam range of the second UE covers the transmit beam range of the first UE, and the signal peak value in the first information and the time-frequency domain resource corresponding to the first information is less than or equal to the threshold value, determining that uplink transmission cannot be performed on the shared frequency band resource.

In the embodiments of the present disclosure, if data transmission on the shared frequency band is detected, if the transmit beam range of the second UE covers the transmit beam range of the first UE, and if the correlation of the first information and the data transmission characteristic of the second UE on the shared frequency band resource is greater than the threshold value, it is determined that the uplink transmission can be performed on the shared frequency band resource. For example, in the application scenario shown in FIG. 2, it is determined that UE2 transmits uplink data in the shared frequency band resource; that is, it is determined that the object that interferes with UE1 is a known interference object, so that UE1 can perform uplink transmission on the shared frequency band resource.

Alternatively, if the data transmission on the shared frequency band is detected, if the transmit beam range of the second UE covers the transmit beam range of the first UE, and if the correlation between the first information and the data transmission characteristic of the second UE on the shared frequency band resource is less than or equal to the threshold value, it is determined that uplink transmission cannot be performed on the shared frequency band resource. For example, in the application scenario shown in FIG. 2, it is determined that UE2 does not transmit uplink data on the shared frequency band resource, but UE3 transmits uplink data in the shared frequency band resource; that is, it is determined that the unknown interference object is interfering with UE1. In this case. UE1 cannot perform uplink transmission on the shared frequency band resource.

In this way, in the embodiments of the present disclosure, it can be accurately determined whether the first UE can perform uplink transmission on the shared frequency band resource. If it is determined that the first UE can perform uplink transmission on the shared frequency band resource, it can reduce the possibility of the first UE losing the opportunity that could have been used for transmission due to detection of the data transmission on the shared frequency band resource, and it can greatly improve the utilization rate of the shared frequency band resource.

In other embodiments, if the first UE and the second UE do not have the precondition of the coverage of the transmit beam ranges, that is, the transmit beam range of the second UE does not cover the transmit beam range of the first UE, then an information processing method according to the embodiments of the present disclosure may also be: if the correlation between the first information and the data transmission characteristic of the second UE on the shared frequency band resource is greater than a threshold value, determining that uplink transmission can be performed on the shared frequency band resource; or, if the correlation between the first information and the data transmission characteristic of the second UE on the shared frequency band resource is less than or equal to the threshold value, determining that the uplink transmission cannot be performed on the shared frequency band resource. In this way, in the embodiments of the present disclosure, it is also possible to determine whether the second UE actually transmits uplink data directly by detecting the correlation between the first information and the data transmission of the second UE on the shared frequency band resource, and then it is determined whether the first UE can use the shared frequency band resource for transmission.

It should be noted that those skilled in the art can understand that the methods provided in the embodiments of the present disclosure may be executed alone, or may be executed together with some methods in the embodiments of the present disclosure or some methods in the related art.

As shown in FIG. 8, an information processing method is provided, and the method is executed by a first UE. The method includes the following steps.

In step S81: if the first UE can perform uplink transmission on the shared frequency band resource, a channel is detected by using a predetermined channel detection mechanism to determine whether the shared frequency band resource can be occupied.

In some embodiments of the present disclosure, the first information may be the first information described in the foregoing step S31.

In one embodiment, the predetermined channel detection mechanism may be any mechanism for detecting a channel; for example, it may be an LBT mechanism with a relatively high channel occupation priority. For example, the mechanism for detecting the channel includes, but is not limited to, one of the following: no LBT mechanism, no random backoff LBT mechanism, random backoff LBT using a fixed-length contention window, and random backoff LBT using a non-fixed-length contention window. In one embodiment, the above-mentioned LBT mechanism with a relatively high channel occupation priority may be a mechanism in which a relatively small contention window is used in the above-mentioned mechanism for detecting a channel.

In the embodiment of the present disclosure, the detection channel may be the detection of the shared frequency band resource.

An embodiment of the present disclosure provides an information processing method, the method is performed by a first UE, and may include: if the first UE can perform uplink transmission on a shared frequency band resource, occupying the shared frequency band resource by using an enhanced channel access method to perform uplink transmission.

In the embodiments of the present disclosure, if the first UE can perform uplink transmission on the shared frequency band resource, the probability of the first UE accessing the channel can be increased by detecting the channel through a predetermined channel detection mechanism, that is, the probability of the first UE occupying the shared frequency band resource to perform the uplink transmission can be increased, so that the utilization rate of using the shared frequency band resource to perform the uplink transmission can be improved.

It should be noted that those skilled in the art can understand that the methods provided in the embodiments of the present disclosure may be executed independently, or may be executed together with some methods in the embodiments of the present disclosure or some methods in the related art.

As shown in FIG. 9, an information processing method is provided, and the method is executed by a first UE. The method includes the following steps.

In step S91: if the first UE cannot perform uplink transmission on the shared frequency band resource, the correlation detection between the first information and the data transmission characteristic of the second UE on the shared frequency band resource is performed again after waiting for a predetermined time.

In some embodiments of the present disclosure, the first information may be the first information described in the foregoing step S31.

In the above step S71, performing the correlation detection between the first information and the data transmission characteristic of the second UE on the shared frequency band resource again after waiting for a predetermined time, may be: detecting whether the correlation of the first information and the data transmission characteristic of the second UE on the shared frequency band resource is greater than the threshold value; or, it may be: if the data transmission on the shared frequency band resource is detected, detecting whether the correlation between the first information and the data transmission characteristic of the second UE on the shared frequency band resource is greater than the threshold value.

In one embodiment, the predetermined time may be pre-configured. In another embodiment, the predetermined time may be determined according to a time interval of historically detecting the correlation between the first information and the data transmission characteristic of the second UE on the shared frequency band resource.

In the embodiments of the present disclosure, after determining that the first UE cannot perform uplink transmission on the shared frequency band resource, the first IE cannot rashly increase the LBT threshold to increase the access probability of the first UE; while the first UE may continue to perform correlation detection between the first information and the data transmission characteristic of the second UE on the shared frequency band resource after waiting for a predetermined time, so that if the subsequent correlation detection meets the condition for the first UE to access the shared frequency band resource, the first UE is enabled to access the shared frequency band resource to perform uplink transmission.

In an information processing method provided by an embodiment of the present disclosure, the method is performed by a first UE, and may include: if the first UE cannot perform uplink transmission on a shared frequency band resource, monitoring data transmission on the shared frequency band resource after waiting for a predetermined time; if the first UE does not detect data transmission on the shared frequency band resource, determining that the first UE can perform uplink transmission on the shared frequency band resource. In this way, the embodiment of the present disclosure can also monitor whether the shared frequency band resource is busy after a predetermined time, and if the shared frequency band resource is idle, it can also be determined that the first UE can perform uplink transmission on the shared frequency band resource.

It should be noted that those skilled in the art can understand that the methods provided in the embodiments of the present disclosure may be executed alone, or may be executed together with some methods in the embodiments of the present disclosure or some methods in the related art.

To further explain any embodiment of the present disclosure, the following example is provided for illustration.

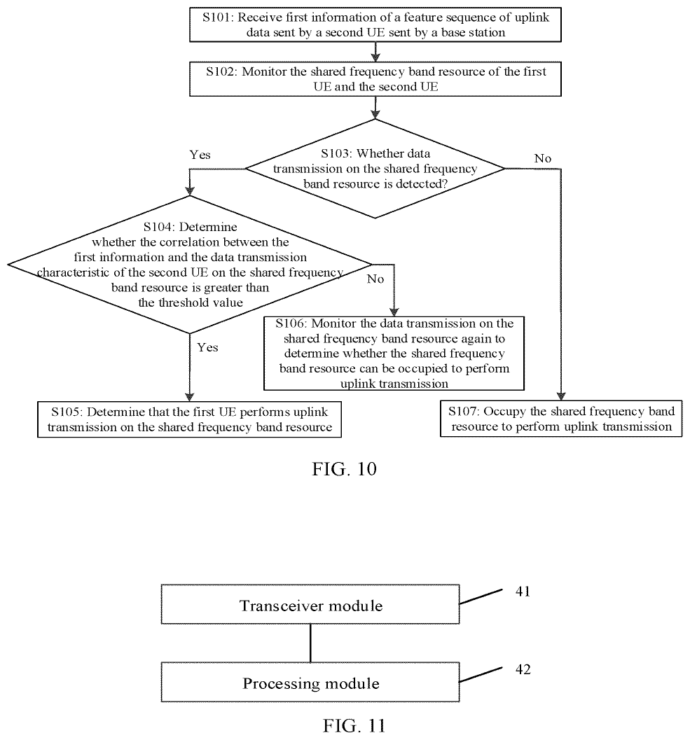

In combination with FIGS. 10 and 2, an information processing method is provided. In the embodiment of the present disclosure, UE1 in FIG. 2 may be considered as the first UE, and UE2 in FIG. 2 may be considered as the second UE; the transmit beam range of the second UE covers the transmit beam range of the first UE. The information processing method provided by an embodiment of the present disclosure includes the following steps.

In step S101: first information of a feature sequence of uplink data sent by a second UE sent by a base station is received. In one embodiment, the first UE receives the DCI sent by the base station, where the DCI carries the first information of the feature sequence of the uplink data sent by the second UE.

In step S102: the shared frequency band resource of the first UE and the second UE is monitored. In one embodiment, the first IE monitors the shared frequency band resource of the first UE and the second UE.

In step S103: it is determined whether data transmission on the shared frequency band resource is detected; if yes, the process goes to step S104; if not, the process goes to step S107. In one embodiment, it is determined whether the first UE detects the data transmission on the shared frequency band resource of the first UE and the second UE; if yes, the process goes to step S104; if not, the process goes to step S107.

In step S104: it is determined whether the correlation between the first information and the data transmission characteristic of the second UE on the shared frequency band resource is greater than the threshold value; if yes, the process goes to step S105; if not, the process goes to step S106. In one embodiment, the first UE detects the correlation between the first information and the data transmission characteristic of the second UE on the shared frequency band resource, and determines whether the correlation is greater than a threshold value; if yes, the process goes to step S105; if not, the process goes to step S106.

In step S105: it is determined that the first UE performs uplink transmission on the shared frequency band resource. In one embodiment, the first UE occupies the shared frequency band resource by using the enhanced access method to perform uplink transmission. For example, the first UE detect the channel by using a predetermined channel detection mechanism to determine whether the shared frequency band resource can be occupied, and after determining that the shared frequency band resource can be occupied, the shared frequency band resource is occupied for uplink transmission.

In step S106: data transmission on the shared frequency band resource is monitored again to determine whether the shared frequency band resource can be occupied to perform uplink transmission. In one embodiment, the first UE waits for a predetermined time to monitor again whether data is transmitted on the shared frequency band resource, and if it does not detect data transmission on the shared frequency band resource, it is determined that the first UE can occupy the shared frequency band resource to perform uplink transmission; if data transmission of the second UE on the shared frequency band resource is detected, it is determined whether the first UE can perform uplink transmission on the shared frequency band resource according to the correlation between the first information and the data transmission characteristic of the second UE on the shared frequency band resource.

In step S107: the shared frequency band resource is occupied to perform uplink transmission. In one embodiment, the first UE occupies the shared frequency band resource to perform uplink transmission.

In the embodiments of the present disclosure, the first UE may acquire the first information of the feature sequence of the uplink data sent by the second UE, and based on whether the correlation between the first information and the data transmission characteristic of the second UE on the shared frequency band resource is greater than the threshold value, determine whether the first UE can perform uplink transmission on the shared frequency band resource; if so, it is determined that the interference of the first UE is caused by the second UE sending uplink data on the shared frequency band resource, and because the second UE is the known interference object, it is determined that the first UE can perform uplink transmission on the shared frequency band resource. In this way, it is possible to reduce the occurrence of a situation in which the opportunity that could have been used for transmission is lost due to detection of the data transmission on the shared frequency band resource, and the utilization rate of the shared frequency band resource can be greatly improved.

And, if it is determined that the correlation between the first information and the data transmission characteristic of the second UE on the shared frequency band resource is less than or equal to the threshold value, then it is determined that the second UE does not actually transmit data on the shared frequency band resource, and it is determined that the interference to the first UE is caused by an unknown interference. In this case, it is possible to monitor the shared frequency band resource again after waiting for a predetermined time, until the shared frequency band resource is idle or it is a known interference object that occupies the shared frequency band resource for data transmission, and then it is determined that the first UE can use the shared frequency band resource to perform uplink transmission; which can improve the utilization rate of the shared frequency band resource.

It should be noted that, in the embodiments of the present disclosure, when the first UE performs correlation detection, it can usually at least know whether the second UE that is in the same coverage interference pair with the first UE transmits data in the shared frequency band resource; for example, in the application scenario shown in FIG. 2. UE1 and UE2 are in the same coverage interference pair, and UE1 at least knows whether UE2 transmits data in the shared frequency band resource to determine whether UE1 can occupy the shared frequency band resource to transmit data.

As shown in FIG. 11, an information processing apparatus is provided, the method is applied to a first UE, and includes a transceiver module 41, configured to receive first information sent by a network device, and configured to monitor data transmission on a shared frequency band resource; where the first information is related to a feature sequence of uplink data; where the shared frequency band resource includes a frequency band resource shared by the first UE and a second UE, and a processing module 42, configured to determine whether uplink transmission can be performed on the shared frequency band resource according to a correlation between the first information and a data transmission characteristic of the second UE on the shared frequency band resource.

An information processing apparatus provided by an embodiment of the present disclosure is applied to a first UE, and may include: a processing module 42, configured to, in response to detecting data transmission of a second UE on a shared frequency band resource, determine whether uplink transmission can be performed on the shared frequency band resource according to a correlation between first information and a data transmission characteristic of the second UE on the shared frequency band resource.

An information processing apparatus provided by an embodiment of the present disclosure is applied to a first UE, and may include: a transceiver module 41, configured to receive downlink control information (DCI) including first information.

In one embodiment, the first information includes but is not limited to at least one of the following:

DMRS configuration information, used for the second UE to transmit a DMRS according to the DMRS configuration information;

DMRS indication information for indicating the feature information obtained by jointly encoding each DMRS configuration information.

In one embodiment, the DMRS configuration information includes but is not limited to at least one of the following:
time domain resource information of a time domain resource for transmitting DMRS;
frequency domain configuration information of a frequency domain resource for transmitting DMRS;
indication information for indicating a transmission mode of the DMRS;
type information of DMRS; the type information of DMRS is for indicating whether the DMRS is a precoding DMRS.

In one embodiment, the time domain resource information includes but is not limited to at least one of the following:
the number of symbols; the number of symbols is for indicating the number of symbols for sending DMRS;
symbol distribution information; the symbol distribution information is for indicating the number of symbols continuously occupied by sending the DMRS in a time domain;
a time domain starting position; the time domain starting position is for indicating a position of a first symbol occupied by the DMRS in the time domain;
a symbol position; the symbol position is for indicating a sequence of symbols occupied by the DMRS.

In one embodiment, the indication information for indicating the transmission mode of the DMRS includes but is not limited to at least one of the following:
frequency domain multiplexing mode information, for indicating a frequency domain multiplexing mode transmission adopted by DMRS;
frequency hopping indication information, for indicating whether there is frequency hopping transmission in the DMRS.

An information processing apparatus provided by an embodiment of the present disclosure is applied to a first UE, and may include a processing module 42, configured to, if a transmit beam range of the second UE covers a transmit beam range of the first UE, and the correlation between the first information and the data transmission characteristic of the second UE on the shared frequency band resource is greater than the threshold value, determine that the uplink transmission can be performed on the shared frequency band resource, or, the processing module 42 is configured to, if the transmit beam range of the second UE covers the transmit beam range of the first UE, and the correlation between the first information and the data transmission characteristic of the second UE on the shared frequency band resource is less than or equal to the threshold value, determine that the uplink transmission cannot be performed on the shared frequency band resource.

An information processing apparatus provided by an embodiment of the present disclosure is applied to a first UE, and may include a processing module 42, configured to, if the transmit beam range of the second UE covers the transmit beam range of the first UE, and a signal peak value in the first information and a time-frequency domain resource corresponding to the first information is greater than a threshold peak value, determine that the uplink transmission can be performed on the shared frequency band resource.

An information processing apparatus provided by an embodiment of the present disclosure is applied to a first UE, and may include a processing module 42, configured to, if the first UE can perform the uplink transmission on the shared frequency band resource, detect a channel by using a predetermined channel detection mechanism to determine whether the shared frequency band resource can be occupied.

An information processing apparatus provided by an embodiment of the present disclosure is applied to a first LIE, and may include a processing module 42, configured to, if the first UE cannot perform uplink transmission on the shared frequency band resource, perform correlation detection between the first information and the data transmission characteristic of the second UE on the shared frequency band resource again after waiting for a predetermined time.

It should be noted that those skilled in the art can understand that the apparatuses provided in the embodiments of the present disclosure may be executed independently, or may be executed together with some apparatuses in the embodiments of the present disclosure or some apparatuses in the related art.

With respect to the apparatuses in the above embodiments, the specific manners for performing operations for individual modules therein have been described in detail in the embodiments regarding the methods, and will not be elaborated herein.

Embodiments of the present disclosure provide a communication device, including a processor and a memory for storing executable instructions of the processor. The processor is configured to: when executing the executable instructions, implement the information processing method according to any embodiment of the present disclosure.

In one embodiment, the communication device may be a UE. For example, the UE is the first UE in any of the foregoing embodiments.

In one embodiment, the communication device may also be a network-side entity; for example, the network-side entity is a core network entity.

The processor may include various types of storage media, which are non-transitory computer storage media, and can continue to memorize and store information thereon after the user equipment is powered off.

The processor may be connected to the memory through a bus or the like, for reading executable programs stored in the memory, for example, at least one of the methods shown in FIG. 3, FIG. 6 to FIG. 10.

An embodiment of the present disclosure further provides a computer-readable storage medium, where the computer-readable storage medium stores instructions, and when the instructions are executed by a processor, the information processing method according to any embodiment of the present disclosure is implemented, for example, at least one of the methods shown in FIG. 3, FIG. 6 to FIG. 10.

With respect to the apparatus or storage medium in the above embodiments, the specific manners for performing operations for individual modules therein have been described in detail in the embodiments regarding the methods, which will not be elaborated herein.

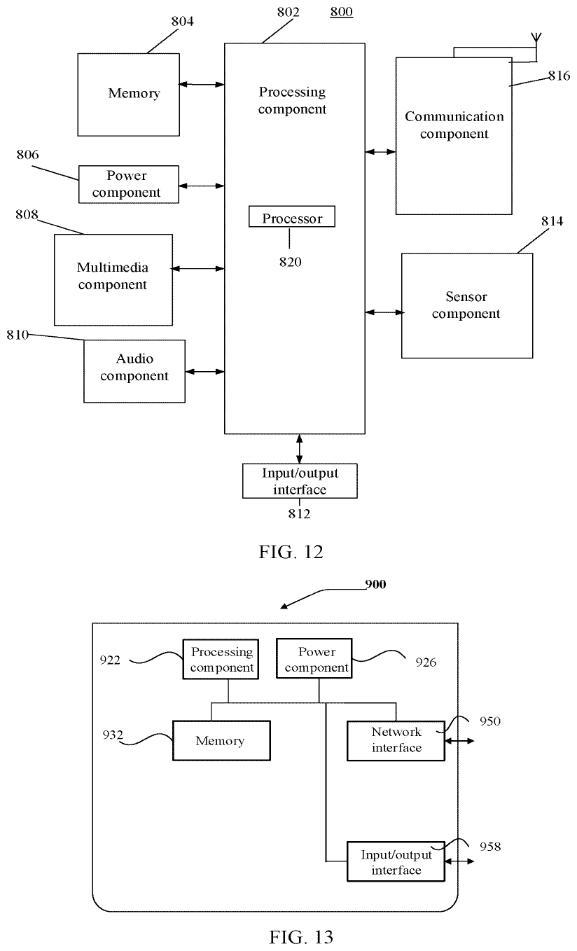

FIG. 12 is a block diagram of a user equipment 800 according to an exemplary embodiment. For example, the user equipment 800 may be a mobile phone, a computer, a digital broadcast terminal, a messaging device, a gaming console, a tablet, a medical device, exercise equipment, a personal digital assistant, and the like.

Referring to FIG. 12, the user equipment 800 may include one or more of the following components: a processing component 802, a memory 804, a power component 806, a multimedia component 808, an audio component 810, an input/output (I/O) interface 812, a sensor component 814, and a communication component 816.

The processing component 802 typically controls overall operations of the user equipment 800, such as the operations associated with display, telephone calls, data communications, camera operations, and recording operations. The processing component 802 may include one or more processors 820 to execute instructions to perform all or part of the steps in the above described methods. Moreover, the processing component 802 may include one or more modules which facilitate the interaction between the processing component 802 and other components. For instance, the processing component 802 may include a multimedia module to facilitate the interaction between the multimedia component 808 and the processing component 802.

The memory 804 is configured to store various types of data to support the operation of the user equipment 800. Examples of such data include instructions for any applications or methods operated on the user equipment 800, contact data, phonebook data, messages, pictures, video, etc. The memory 804 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 806 provides power to various components of the user equipment 800. The power component 806 may include a power management system, one or more power sources, and any other components associated with the generation, management, and distribution of power in the user equipment 800.

The multimedia component 808 includes a screen providing an output interface between the user equipment 800 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 808 includes a front camera and/or a rear camera. The front camera and the rear camera may receive an external multimedia datum while the user equipment 800 is in an operation mode, such as a photographing mode or a video mode. Each of the front camera and the rear camera may be a fixed optical lens system or have focus and optical zoom capability.

The audio component 810 is configured to output and/or input audio signals. For example, the audio component 810 includes a microphone (“MIC”) configured to receive an external audio signal when the user equipment 800 is in an operation mode, such as a call mode, a recording mode, and a voice recognition mode. The received audio signal may be further stored in the memory 804 or transmitted via the communication component 816. In some embodiments, the audio component 810 further includes a speaker to output audio signals.

The I/O interface 812 provides an interface between the processing component 802 and peripheral interface modules, such as a keyboard, a click wheel, buttons, and the like. The buttons may include, but are not limited to, a home button, a volume button, a starting button, and a locking button.

The sensor component 814 includes one or more sensors to provide status assessments of various aspects of the user equipment 800. For instance, the sensor component 814 may detect an open/closed status of the user equipment 800, relative positioning of components, e.g., the display and the keypad, of the user equipment 800, a change in position of the user equipment 800 or a component of the user equipment 800, a presence or absence of user contact with the user equipment 800, an orientation or an acceleration/deceleration of the user equipment 800, and a change in temperature of the user equipment 800. The sensor component 814 may include a proximity sensor configured to detect the presence of nearby objects without any physical contact. The sensor component 814 may also include a light sensor, such as a CMOS or CCD image sensor, for use in imaging applications. In some embodiments, the sensor component 814 may also include an accelerometer sensor, a gyroscope sensor, a magnetic sensor, a pressure sensor, or a temperature sensor.

The communication component 816 is configured to facilitate communication, wired or wirelessly, between the user equipment 800 and other devices. The user equipment 800 can access a wireless network based on any communication standard, such as WiFi, 2G, or 3G, or a combination thereof. In one exemplary embodiment, the communication component 816 receives a broadcast signal or broadcast associated information from an external broadcast management system via a broadcast channel. In one exemplary embodiment, the communication component 816 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the user equipment 800 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is also provided a non-transitory computer-readable storage medium including instructions, such as included in the memory 804, executable by the processor 820 in the user equipment 800, for performing the above-described methods. For example, the non-transitory computer-readable storage medium may be a ROM, a RAM, a CD-ROM, a magnetic tape, a floppy disc, an optical data storage device, and the like.

As shown in FIG. 13, an embodiment of the present disclosure shows a structure of a base station. For example, the base station 900 may be provided as a network-side device. Referring to FIG. 13, the base station 900 includes a processing component 922 that further includes one or more processors, and memory resources represented by a memory 932 for storing instructions executable by the processing component 922, such as application programs. The application programs stored in the memory 932 may include one or more modules each corresponding to a set of instructions. Further, the processing component 922 is configured to execute the instructions to perform any of the above described methods applied to the base station, e.g., the methods shown in FIG. 3 and FIGS. 6 to 10.

The base station 900 may also include a power component 926 configured to perform power management of the base station 900, wired or wireless network interface(s) 950 configured to connect the base station 900 to a network, and an input/output (I/O) interface 958. The base station 900 may operate based on an operating system stored in the memory 932, such as Windows Server™, Mac OS X™, Unix™, Linux™, FreeBSD™, or the like.

Other embodiments of the present disclosure will be apparent to those skilled in the art from consideration of the specification and practice of the present disclosure. The present disclosure is intended to cover any variations, uses, or adaptations of the present disclosure following the general principles thereof and including such departures from the present disclosure as come within known or customary practice in the art. It is intended that the specification and examples be considered as exemplary only, with a true scope and spirit of the invention being indicated by the following claims.

It will be appreciated that the present disclosure is not limited to the exact construction that has been described above and illustrated in the accompanying drawings, and that various modifications and changes can be made without departing from the scope thereof. It is intended that the scope of the present disclosure only be limited by the appended claims.

1. An information processing method, wherein the method is executed by a first user equipment (UE), and the method comprises;
receiving first information sent by a network device, wherein the first information is related to a feature sequence of uplink data;
monitoring data transmission on a shared frequency band resource, wherein the shared frequency band resource comprises a frequency band resource shared by the first UE and a second UE;
determining whether an uplink transmission can be performed on the shared frequency band resource according to a correlation between the first information and a data transmission characteristic of the second UE on the shared frequency band resource.

2. The method according to claim 1, wherein the receiving the first information sent by the network device comprises:
receiving downlink control information (DCI) comprising the first information.

3. The method according to claim 1, wherein the first information comprises at least one of:
demodulation reference signal (DMRS) configuration information for the second UE to transmit a DMRS according to the DMRS configuration information;
DMRS indication information for indicating feature information obtained by jointly encoding each of the DMRS configuration information.

4. The method according to claim 3, wherein the DMRS configuration information comprises at least one of:
time domain resource information of a time domain resource for transmitting the DMRS;
frequency domain configuration information of a frequency domain resource for transmitting the DMRS;
indication information for indicating a transmission mode of the DMRS;
type information of the DMRS, wherein the type information of the DMRS is for indicating whether the DMRS is a precoding DMRS.

5. The method according to claim 4, wherein the time domain resource information comprises at least one of:
a number of symbols, wherein the number of symbols is for indicating a number of symbols for sending the DMRS;
symbol distribution information, wherein the symbol distribution information is for indicating a number of symbols continuously occupied by sending the DMRS in a time domain;
a time domain starting position, wherein the time domain starting position is for indicating a position of a first symbol occupied by the DMRS in the time domain;
a symbol position, wherein the symbol position is for indicating a sequence of symbols occupied by the DMRS.

6. The method according to claim 4, wherein the indication information for indicating the transmission mode of the DMRS comprises at least one of:
frequency domain multiplexing mode information for indicating a frequency domain multiplexing mode transmission adopted by the DMRS;
frequency hopping indication information for indicating whether there is a frequency hopping transmission in the DMRS.

7. The method according to claim 1,
wherein determining whether the uplink transmission can be performed on the shared frequency band resource according to the correlation between the first information and the data transmission characteristic of the second UE on the shared frequency band resource, comprises one of:
determining that the uplink transmission can be performed on the shared frequency band resource, wherein a transmit beam range of the second UE covers a transmit beam range of the first UE, and the correlation between the first information and the data transmission characteristic of the second UE on the shared frequency band resource is greater than a threshold value; or,
determining that the uplink transmission cannot be performed on the shared frequency band resource, wherein the transmit beam range of the second UE covers the transmit beam range of the first UE, and the correlation between the first information and the data transmission characteristic of the second UE on the shared frequency band resource is less than or equal to the threshold value.

8. The method according to claim 7, wherein determining whether the uplink transmission can be performed on the shared frequency band resource, comprises:
determining that the uplink transmission can be performed on the shared frequency band resource, wherein the transmit beam range of the second UE covers the transmit beam range of the first UE, and a signal peak value in the first information and a time-frequency domain resource corresponding to the first information is greater than a threshold peak value.

9. The method according to claim 7, further comprising:
detecting a channel by using a predetermined channel detection mechanism to determine whether the shared frequency band resource can be occupied, wherein the first UE can perform the uplink transmission on the shared frequency band resource.

10. The method according to claim 7, further comprising:
detecting the correlation between the first information and the data transmission characteristic of the second UE on the shared frequency band resource again after waiting for a predetermined time, wherein the first UE cannot perform the uplink transmission on the shared frequency band resource.

11. An information processing apparatus, comprising:
a processor;
a memory for storing executable instructions of the processor;
wherein the processor is configured to;
receive first information sent by a network device, and monitor data transmission on a shared frequency band resource; wherein the first information is related to a feature sequence of uplink data; wherein the shared frequency band resource comprises a frequency band resource shared by the first UE and a second UE;
determine whether an uplink transmission can be performed on the shared frequency band resource according to a correlation between the first information and a data transmission characteristic of the second UE on the shared frequency band resource.

12. The apparatus according to claim 11, wherein
the processor is further configured to receive downlink control information (DCI) comprising the first information.

13. The apparatus according to claim 11, wherein the first information comprises at least one of:
demodulation reference signal (DMRS) configuration information for the second UE to transmit a DMRS according to the DMRS configuration information;
DMRS indication information for indicating feature information obtained by jointly encoding each of the DMRS configuration information.

14. The apparatus according to claim 13, wherein the DMRS configuration information comprises at least one of:
time domain resource information of a time domain resource for transmitting the DMRS;
frequency domain configuration information of a frequency domain resource for transmitting the DMRS;
indication information for indicating a transmission mode of the DMRS;
type information of the DMRS; wherein the type information of the DMRS is for indicating whether the DMRS is a precoding DMRS.

15. The apparatus according to claim 14, wherein the time domain resource information comprises at least one of:
a number of symbols; wherein the number of symbols is for indicating a number of symbols for sending the DMRS;
symbol distribution information; wherein the symbol distribution information is for indicating a number of symbols continuously occupied by sending the DMRS in a time domain;
a time domain starting position; wherein the time domain starting position is for indicating a position of a first symbol occupied by the DMRS in the time domain;
a symbol position; wherein the symbol position is for indicating a sequence of symbols occupied by the DMRS.

16. The apparatus according to claim 1, wherein the indication information for indicating the transmission mode of the DMRS comprises at least one of:
frequency domain multiplexing mode information for indicating a frequency domain multiplexing mode transmission adopted by the DMRS;
frequency hopping indication information for indicating whether there is a frequency hopping transmission in the DMRS.

17. The apparatus according to claim 11, wherein
the processor is further configured to;
determine that the uplink transmission can be performed on the shared frequency band resource, wherein a transmit beam range of the second UE covers a transmit beam range of the first UE, and the correlation between the first information and the data transmission characteristic of the second UE on the shared frequency band resource is greater than a threshold value;
or,
the processor is further configured to; determine that the uplink transmission cannot be performed on the shared frequency band resource, wherein the transmit beam range of the second UE covers the transmit beam range of the first UE, and the correlation between the first information and the data transmission characteristic of the second UE on the shared frequency band resource is less than or equal to the threshold value.

18. The apparatus according to claim 17, wherein
the processor is further configured to;
determine that the uplink transmission can be performed on the shared frequency band resource, wherein the transmit beam range of the second UE covers the transmit beam range of the first UE, and a signal peak value in the first information and a time-frequency domain resource corresponding to the first information is greater than a threshold peak value.

19. The apparatus according to claim 17, wherein
the processor is further configured to, detect a channel by using a predetermined channel detection mechanism to determine whether the shared frequency band resource can be occupied, wherein the first UE can perform the uplink transmission on the shared frequency band resource.

20-21. (canceled)

22. A computer-readable storage medium, wherein the computer-readable storage medium stores instructions that, when executed by a processor, implement the information processing method of claim 1.
